(19) United States
(12) Patent Application Publication
(10) Pub. No.: US 2008/0133579 A1
(43) Pub. Date: Jun. 5, 2008

(54) MAP SERVICE SYSTEM AND METHOD

(75) Inventor: Seung-Phill LIM, Yongin-si (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: NHN Corporation, Seongnam-si (KR)

(21) Appl. No.: 11/942,655

(22) Filed: Nov. 19, 2007

(30) Foreign Application Priority Data
Nov. 17, 2006 (KR) 10-2006-0113750

(51) Int. Cl. G06F 17/30

(52) U.S. Cl. 707/102; 707/E17.018

(57) ABSTRACT

Map service system and method are provided. The system includes a base map database (DB) for containing base map information comprising geographical information relating to a certain region; a map processing server for transmitting the base map information to a first user and receiving first user layer information which is generated based on the base map information and comprises at least one object information and position identifier (PID) associated to the object information, from the first user; and a user layer DB for containing the first user layer information. Accordingly, by allowing the user to freely create his/her intended map, the map can be customized and the user's various needs can be satisfied.

### CROSS-REFERENCE TO RELATED APPLICATIONS

This application claims the benefit under 35 U.S.C. § 119 (a) from Korean Patent Application No. 10-2006-0113750 filed on Nov. 17, 2006, the entire disclosure of which is incorporated herein by reference.

### BACKGROUND OF THE INVENTION

The present invention relates to a map service system and more particularly to an Internet based map service system which provides user specific information and minimizes unneeded objects.

The Internet is now commonly used in daily life. Internet services such as electronic commerce, Internet banking, and online games are prevalently used. Recently, Internet map services which provide geographical information over the Internet has become one of the Internet services frequently used by a number of users.

In general, the Internet user acquires the map of his/her intended region by searching using an address or a business name in a map search site. By clicking the map of the intended region in the map provided from the map search site, the user can access the map of the intended region. The map provided to the user shows various objects such as geographical names, roads, buildings, and business names. However, the size and the scale of the Internet map are limited. Accordingly, as the number of objects to be represented increases, the objects are likely to overlap each other to thus lower the readability of the map. To raise the readability, the objects of the same type are arranged in one layer, rather than showing all objects in the map. When the user selects his/her intended object, only the layer corresponding to the selected object is represented in the map. Still, the selected layer may contain too many objects of the same type and accordingly, the displayed objects may overlap each other. Even if the selected layer does not contain many objects of the same type, the objects of the selected layer may overlap each other as the scale of the map is reduced or may not be shown at all.

Meanwhile, since the map provided to the user is a mere image and provides little information, the user's various needs are not fully satisfied.

### SUMMARY OF THE INVENTION

An aspect of the present invention is to provide a map service system and method for freely implementing a user's intended map.

Another aspect of the present invention is to provide a map service system and method for satisfying user's various needs by generating and exchanging information by means of a map.

According to an aspect of the present invention, a map service system includes a base map database (DB) for containing base map information comprising geographical information relating to a certain region; a map processing server for transmitting the base map information to a first user and receiving first user layer information which is generated based on the base map information and comprises at least one object information and position identifier (PID) associated to the object information, from the first user; and a user layer DB for containing the first user layer information.

The map processing server may transmit the first user layer information stored to the user layer DB to the first user and receive second user layer information generated based on the first user layer information from the first user. The user layer DB may contain the second user layer information.

The map processing server may transmit the first user layer information stored to the user layer DB to a second user and receive second user layer information generated based on the first user layer information from the second user. The user layer DB may contain the second user layer information.

The user layer DB may contain the second user layer information generated by the first user and third user layer information generated by the second user, and the map processing server may transmit the second and third user layer information relating to the certain region to the first user according to a map information transmission request for the certain region from the first user.

The first user layer information may be generated based on at least one of the base map information, the second user layer information, and the third user layer information according to a selection of the first user.

At least one of first, second and third user layers corresponding to the first, second and third user layer information respectively may be displayed by overlapping a base map corresponding to the base map information.

The base map information may include basic layer information and at least one selectable base map layer information.

The object information may include content data or link information linked to the content data.

The object information may include content information provided from a user terminal of the first user.

The map service system may further include a content DB for containing content information; and a search server for providing the content information to the first user in response to a search query. The object information may include the content information.

The PID may point to a position of an object corresponding to the object information in a base map corresponding to the base map information.

According to another aspect of the present invention, a map service method includes transmitting base map information comprising geographical information relating to a certain region to a first user; receiving first user layer information which is generated based on the base map information and comprises at least one object information and a position identifier (PID) associated to the object information, from the first user; and storing the first user layer information.

A computer-readable medium stores a program to execute the method and one of the operations of the map service system.

### BRIEF DESCRIPTION OF THE DRAWING FIGURES

FIG. 1 is a block diagram of a map service system according to an embodiment of the present invention;

FIG. 2 is a simplified diagram of a user layer generated according to an embodiment of the present invention;

FIG. 3 is a simplified diagram of a user interface of the application program of FIG. 1; and

FIGS. 4 and 5 are simplified diagrams of the user layer generation according to an embodiment of the present invention.

### DETAILED DESCRIPTION OF THE SPECIFIC EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

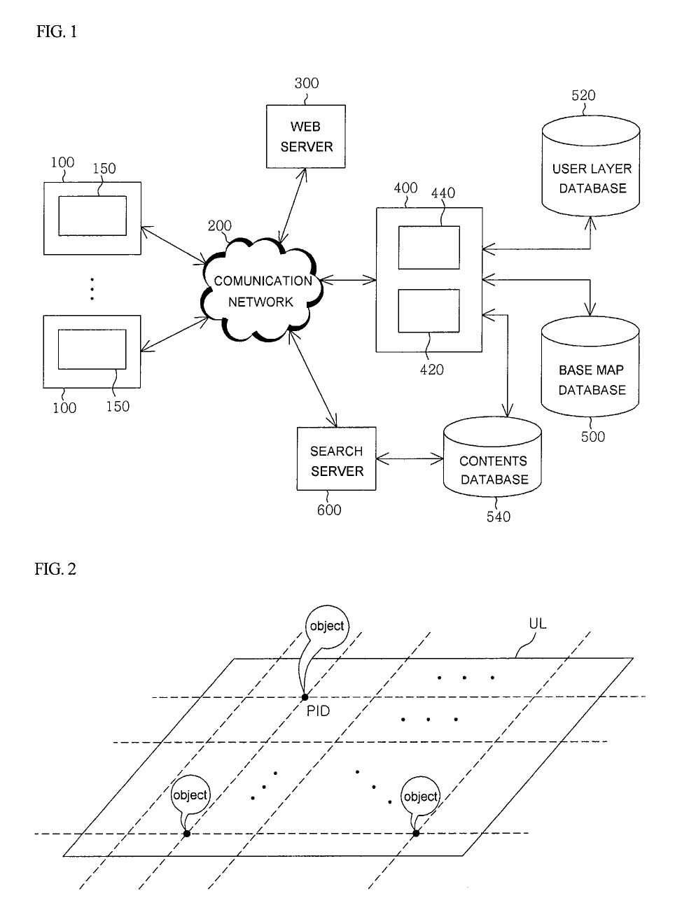

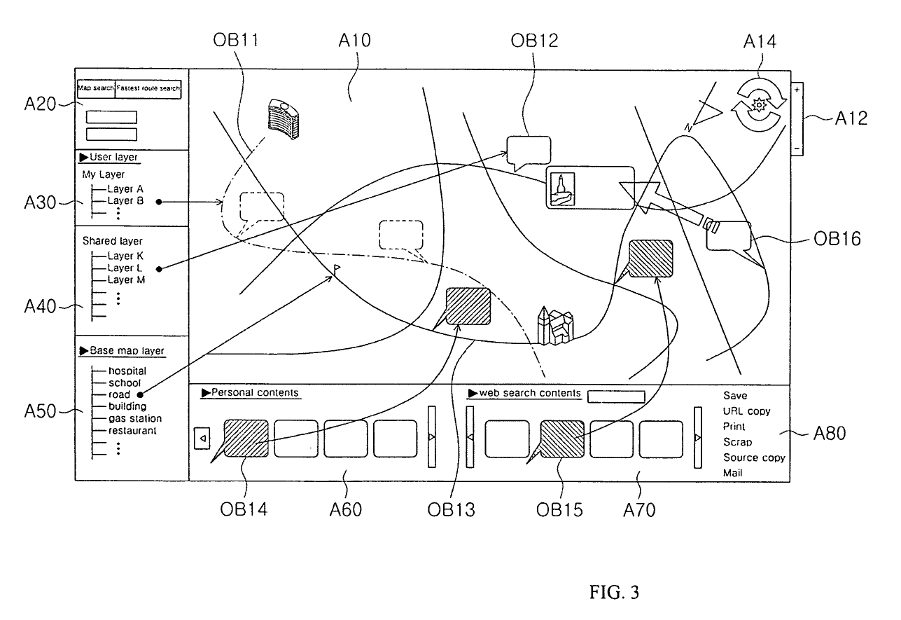

A map service system according to an embodiment of the present invention is described in detail by referring to FIGS. 1 and 2.

FIG. 1 is a block diagram of the map service system according to an embodiment of the present invention, and FIG. 2 is a simplified diagram of a user layer generated according to an embodiment of the present invention.

The map service system of FIG. 1 includes a web server 300, a map processing server 400, a base map database (DB) 500, a user layer DB 520, a content DB 540, and a search server 600. The map service system is connected to a plurality of user terminals 100 over a communication network 200. The base map database 500 and the user layer DB 520 may be located in the same server or in different servers.

The user terminal 100 transmits and receives information by accessing the map service system to use the Internet map service. The user terminal 100 can employ a terminal including a memory means (or memory device) and a microprocessor with the operation capability, such as desktop computer, notebook computer, workstation, palmtop computer, personal digital assistant (PDA), web pad, mobile phone, smart phone, and telematics terminal.

The user terminal 100 includes a communication module (not shown) for accessing the map service system over the communication network 200, and an application program 150. The user terminal 100 may include a global positioning system (GPS) reception module (not shown) for the navigation.

The application program 150 accesses the map service system via the communication network 200 and carries out various functions according to a user's requests. An example of the application program 150 can be, but not limited to, a web browser such as Internet Explorer developed by Microsoft, or a dedicated program provided by the map service system. To execute a specific function, the application program 150 may include a module implemented using active X.

The application program 150 displays the map by interpreting map information received from the map service system. Using the application program 150, the user can generate a user layer. The application program 150 sends user layer information corresponding to the generated user layer to the map service system to store it to the map service system. The application program 150 may receive pre-stored user layer information from the map service system and display the user layer or generate a new user layer based on the received information.

The user layer displays objects of interest to a user in a virtual map. Referring to FIG. 2, a user layer (UL) includes a plurality of points and objects associated with the points. The point corresponds to a geographic location or position. Each point is associated with a position identifier (PID). The user layer may include a plurality of objects corresponding to a plurality of PIDs, or a plurality of objects corresponding to a single PID. Also, a plurality of PIDs may correspond to a single object.

The objects include images such as buildings, roads, and figures, texts such as geographical names and business names, multimedia contents created by the user (e.g., episodes, pictures, still images, videos, voice, and music), document contents contained in blogs, cafes, knowledge information (e.g., knowledge iN, news, and real estate information), and search result contents.

The PID points to a specific spot on the ground (or a specific geographic location). A plurality of places can be set on the ground and different PIDs can be assigned to the places. Hence, the points can be specified using the PIDs. For example, if the ground is divided into grids, PIDs can be allocated to the points where the horizontal lines and the vertical lines (e.g., latitudes and longitudes) cross each other. The PID can be expressed as XY coordinates or serial numbers. It is not necessary that the size of the grid is constant all over the ground. For example, the size 1 m×1 m can be set for the region, such as downtown, where many objects are required per unit area, and the greater size can be set for the region, such as mountain or river, where less objects are required per unit area. By contrast, the PID can be allocated per lot number or per random point.

The user layer information includes a user layer ID number, user information relating to the user who created the corresponding user layer, name of the user layer, description of the user layer, PID, and object information. The user layer information can further include information for the association with the GPS, information for the association with point of interest (POI), and information indicative of the direction of the user layer.

The object information can include the name, the type, the description of the corresponding object, and link information indicative of the position of the object. Instead of the link information, the object information may include object data constituted as a file.

The application program 150 can generate the user layer information using anyone of the following: Standard Generalized Markup Language (SGML)-based web programming language, Hypertext Markup Language (HTML) and Extensible Markup Language (XML), or other types of markup languages. The markup language used may vary according to application. In yet another implementation, the application program 150 may generate the user layer information in other ways without using a markup language.

Referring back to FIG. 1, the communication network 200 can be any wired or wireless communication network, e.g., Local Area Network (LAN), Metropolitan Area Network (MAN), Wide Area Network (WAN), and Internet.

The web server 300 provides the map service web pages to the user terminal 100. In the web pages, the user can request account creation or user authentication. In response, the web server 300 performs the request. The web server 300 provides information required for the user terminal 100 to access the map processing server 400. When the application program 150 is not yet installed to the user terminal 100, the web server 300 installs the application program 150. When a newer version of the application program 150 is available, the application program 150 can update to the new version.

When the user requests the map of a region, the map processing server 400 reads the corresponding base map information from the base map DB 500 and transmits the read information to the user terminal 100 to display the corresponding base map in the user terminal 100. Also, the map processing server 400 reads user layer information relating to the corresponding region from the user layer DB 520 and transmits the read information to the user terminal 100. Herein, the user layer information relating to the corresponding region can imply that, for example, the PID contained in the user layer information corresponds to the place in the corresponding region. The map processing server 400 is also configured to receive the user layer information from the user terminal 100 and stores it in the user layer DB 520. Meanwhile, if the user terminal 100 transmits the object data as a file, the map processing server 400 may store the received data to the content DB 540 or a separate DB (not shown).

The base map includes a basic layer and a plurality of base map layers. The basic layer includes contours and boundaries of the map, rivers, and cities displayed in the user terminal 100. The basic layer provides a visual representation of a region or the Earth's surface, i.e., geographical information. Each base map layer contains objects of the same type in the present implementation. The examples of the objects include restaurants, hospitals, gas stations, parks, schools, roads, subways, buildings, bridges, stadiums, apartments, public institutions, banks, hotels, churches, markets, shopping towns, historic sites, and government and public offices.

The base map information includes basic layer information and base map layer information corresponding to the basic layer and the base map layers respectively. The basic layer information can be vector information or image information. The basic layer information can be compressed for the transmission and the user terminal 300 can decompress the information. The base map layer information includes the corresponding object information and the PID of the corresponding object.

The user can select and display a particular base map layer in the user terminal 100. The selected base map layer is displayed overlapped with the basic layer. Part of the base map layer can be displayed together with the basic layer as the default, or the default of each base map layer can be set according to the user's selection.

The map processing server 400 includes a base map management module 420 and a user layer management module 440. Two modules 420 and 440 control the storing, the holding, and the outputting of the base map information and the user layer information in the base map DB 500 and the user layer DB 520. The modules 420 and 440 can be implemented in a separate server from the map processing server 400.

The base map DB 500 is connected to the map processing server 400. The base map DB 500 contains the base map information. According to the request from the map processing server 400, the base map DB 500 provides the stored base map information to the map processing server 400. The base map information can be continuously updated and stored to the base map DB 500.

The user layer DB 520 is connected to the map processing server 400. The user layer DB 520 contains the user layer information received from the map processing server 400. According to the request from the map processing server 400, the user layer DB 520 provides the stored user layer information to the map processing server 400.

The search server 600 receives a search query from the user and searches the content DB 540 based on the query. After retrieving the contents for the query in the content DB 540, the search server 600 transmits the retrieved content information to the user terminal 100. The user may arbitrarily select the contents displayed as the search result and insert the selected contents to the user layer as the object. In doing so, the link information indicative of the corresponding contents, instead of the content data, can be attached to the user layer information, to thus reduce the size of the user layer information.

The content DB 540 contains multimedia contents such as music, photos, and videos, and document contents such as documents, news, expertise, and knowledge information documents created by the user, which are posted in cafes or blogs. The content DB 540 can store the contents according to their categories by classifying the contents of the same type to one category, or store the contents by dividing the contents to separate DBs based on their categories.

If the user terminal 100 includes a GPS reception module or is a telematics terminal, it can perform a navigation function. More specifically, the user terminal 100 calculates its current position based on information received from a GPS satellite and transmits the current position to the map processing server 400. The map processing server 400 transmits the base map information and the user layer information of the current position to the user terminal 100, and the user terminal 100 receives and displays the information. Using a separate program, the user terminal 100 can calculate an optimum path to the destination and display the path in the map to guide the user. To the contrary, the base map related information may be stored to the user terminal 100 and only the user layer information relating to the user's path may be received from the map processing server 400 and displayed together with the base map.

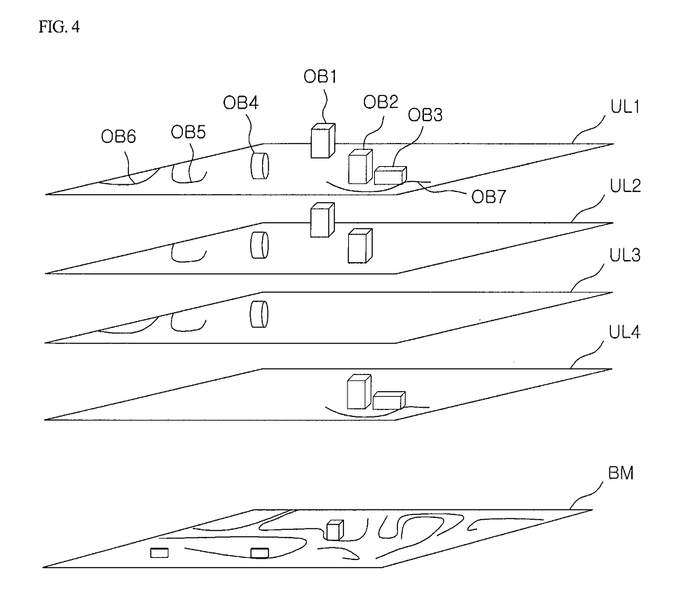

Now, a user interface for generating the user layer is explained in detail by referring to FIG. 3.

FIG. 3 is a simplified diagram of a user interface of the application program of FIG. 1.

The user interface of the application program 150 of FIG. 3 includes a map area A10 showing the map, a map search area A20, user layer regions A30 and A40, a base map layer area A50, a personal content area A60, a web search content area A70, and a menu area A80. The user interface includes a zoom-in/zoom-out button A12 and a rotation button A14.

The map area A10 displays the base map based on the base map information received from the map processing server 400. The base map can be displayed overlapped with the user layer selected by the user. The user can freely edit the map to delete the object in the map area A10 or to move the object to an intended spot. For example, the user can drag-and-drop the content object OB16. In this case, the PID assigned to the object OB16 is changed to the moved spot. The user can enlarge or reduce the map displayed in the map area A10 using the zoom-in/zoom-out button A12, and can rotate the entire map displayed in the map area A10 clockwise or counterclockwise using the rotation button A14.

Since the user layer includes the PID and the associated object regardless of the reduced scale, they can be displayed regardless of the reduced scale of the current map in the map area A10. That is, even when the base map is a large-scale map or a small-scale map, the intended object can be displayed at the intended spot. For example, a customized travel map can be created by selecting the small-scale map of the central districts as the base map and inserting the pictures and videos taken during the travel of the central districts into the visited sites of the base map.

The map search area A20 displays ‘map search’ and ‘fastest route search’ menus. Using the ‘map search’ menu, the user can display the map corresponding to his/her intended address or business name in the map area A10. When the user inputs the address or the business name in the search field and requests the search, the map processing server 400 displays a list of results fit for the input address or business name. Next, when the user selects a desired item in the list, the map processing server 400 transmits the corresponding base map information to the user terminal 100 and the application program 150 interprets the received information and displays the corresponding base map in the map area A10. All or part of the user layer information relating to the corresponding spot can be transmitted. Using the ‘fastest route search’ menu, the user can acquire the optimum path, the fastest path, the distance, and the transit time from the starting point to the destination.

The user layer area is divided into a My layer area A30 and a shared layer area A40. The My layer area A30 displays names of user layers generated by the user. In addition to the user layer names, the My layer area A30 may further display descriptions of the user layers. The user layer displayed in the My layer area A30, which relates to the base map displayed in the map area A10, may be displayed first. To activate the My layer area A30, the user needs to pass through the user authentication in advance.

When the user layer name is selected in the My layer area A30, the objects included in the selected user layer are displayed in the base map. Each object is displayed at the spot indicated by its PID. The user can select and display a plurality of user layers in the map area A10 by overlapping them, and edit the objects of the user layers at will. Even when the plurality of user layers is overlapped and the same or different objects on different layers overlap each other, the user can delete or move the objects to not overlap each other.

For example, when the user selects the layer B in the My layer area A30, the road object OB11 as indicated by the dotted line in the map area A10 and two content objects connected to the road are displayed over the base map. The figure representing the content object may show the name and the description of the contents. Upon clicking the figure, the corresponding content is opened.

The shared layer area A40 displays names of user layers created by other user (hereafter, referred to as “shared layers”). In addition to the names of the shared layers, the shared layer area A40 may further display descriptions of the shared layers and information of the user who created the shared layers. The shared layers can be displayed in the shared layer area A40 based on the order of the popularity or the number of times of selected by users.

Similar to the My layer area A30, the user can arbitrarily select the user layer in the shared layer area A40. Accordingly, objects included in the selected user layer are displayed over the base map. For example, when the layer L is selected, the content object OB12 of the selected user layer is displayed in the map area A10. Namely, the user can create his/her own user layer by selecting the shared layer created by the other user, by using some objects of the shared layer created by that user, or by selecting the shared layer created by one user and adding some objects of the shared layer created by another user.

The base map layer area A50 displays names of the base map layers related to the base map of the corresponding region. The user can select and display a random base map layer over the basic layer. When the user selects one of the base map layer names, objects included in the selected base map layer are displayed in the map area A10. For example, when the road is selected, the road is displayed and overlapped over the basic layer. The user can select and delete part of the road displayed in the map area A10, as well as the objects.

The personal content area A60 displays personal contents contained in the user terminal 100 or personal contents separately registered and stored to the map service system. For example, the personal contents OB14 can be dragged and dropped into the map area A10 to add to the current user layer displayed in the map area A10. As such, when the user inserts his/her object to a spot on the user layer, the object information corresponding to that object is associated with the PID corresponding to that spot on the user layer. A plurality of contents may be inserted to the user layer.

The web search content area A70 includes a search field so that the user can search for his/her intended contents using the search field. The search server 600 displays the corresponding contents in the web search content area A70 by inquiring to the content DB 540 and the separate DB, or displays the contents by inquiring of the contents provided from an external cyber space. Similar to the personal content area A60, by dragging and dropping the search contents OB15 displayed in the web search content area A70 into the map area A10, the contents OB15 can be added as the object to the user layer being displayed in the map area A10.

The menu area A80 displays various function menus executable while the user creates the user layer. The Save function creates a new user layer including the objects currently displayed in the map area A10 and stores the corresponding user layer information to the user layer DB 520. When the user layer information is stored, its name is assigned, its description can be attached, and whether to share the user layer information can be set. Note that a user layer can be displayed, modified, and then saved as the same name. The user may store the user layer with only the user's PIO indicated by the PID, without including any objects.

URL or source of the content object or the user layer can be copied and attached to another user layer (URL copy and Source copy). The map displayed in the map area A10 can be printed (Print), and appended to an e-mail (Mail).

Meanwhile, the map service system according to an embodiment of the present invention can provide the map service to the user in association with other service system such as blog, café, knowledge information, search, news, and real estate. That is, the map generated in the map service system can be provided to and displayed in another service system (Scrap), and the contents created in other service system can be added to the user layer.

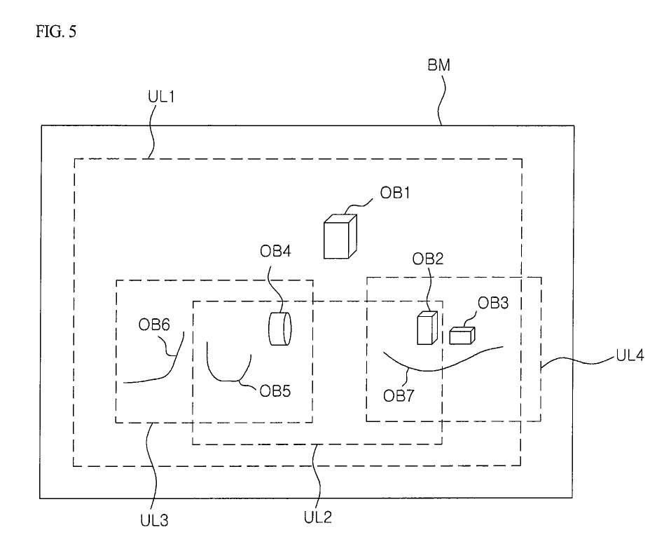

Hereafter, the generation of the user layer is described in further detail by referring to FIGS. 4 and 5.

FIGS. 4 and 5 are simplified diagrams of the user layer generation according to an embodiment of the present invention.

First through fourth user layer UL1 through UL4 created based on the base map BM are displayed in FIGS. 4 and 5. More particularly, FIG. 4 is a perspective view of the user layers UL1 through UL4 and the base map BM that are shown individually, and FIG. 5 is a plane view of the user layers UL1 through UL4 overlapping the base map BM.

The first user layer UL1 includes objects OB1 through OB7, the second user layer UL2 includes objects OB1, OB2, OB4 and OB5, the third user layer UL3 includes objects OB4, OB5 and OB6, and the fourth user layer UL4 includes objects OB2, OB3 and OB7. Herein, while the objects OB1 through OB4 indicate buildings and the objects OB5 through OB7 indicate roads, each object OB1 through OB7 may be an object of a different type. The first through fourth user layers UL1 through UL4 can be placed in the My layer area A30 or the shared layer area A40, and can be created by the same user or by different users. For example, each user layer may have been created by a different user.

If the second user layer UL2 is created based on the fourth user layer UL4, the user can create the second user layer UL2 by deleting the objects OB3 and OB7 of the fourth user layer UL4 and adding the objects OB1, OB4 and OB5. To create the first user layer UL1 based on the second and fourth user layers UL2 and UL4, the user can create the first user layer UL1 by adding the object OB6. In doing so, the user may delete or leave one of the overlapping objects OB2. To create the third user layer UL3 based on the first user layer UL1, the user can create the third user layer UL3 by merely deleting the objects OB1, OB2, OB3 and OB7 of the first user layer UL1.

The map displayed as described above may be two dimensional or three dimensional.

The embodiment of the present invention includes a computer-readable medium storing program commands to execute operations realized by various computers. The medium records a program for the operations of the map service system mentioned above. The medium can contain program commands, data files, and data structures alone or in combination. Examples of the medium include a magnetic medium such as hard disk, floppy disk, and magnetic tape, an optical recording medium such as CD and DVD, a magneto-optical medium such as floptical disk, and a hardware device containing and executing program commands, such as ROM, RAM, and flash memory. The medium can be a transmission medium, such as optical or metallic line and waveguide, including subcarriers which carry signals to define program commands and data structure. Examples of the program command include a machine language created by a compiler and a high-level language executable by the computer using an interpreter.

As set forth above, by creating a new user layer based on the base map or the user layer, the user can freely realize his/her intended map to acquire his/her customized map. In addition, the user's various needs can be satisfied by allowing the user to insert the user created contents into the user layer and to share the user layer with other users.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A map service system comprising:
a base map database configured to store base map information comprising geographical information relating to a geographical location;
a map processing server configured to transmit the base map information to a first user and receive first user layer information which is generated based on the base map information from the first user, the first user layer information including at least one object information and a position identifier associated with the object information; and
a user layer database configured to store the first user layer information received from the first user.

2. The map service system of claim 1, wherein the map processing server is configured to transmit the first user layer information stored in the user layer database to the first user and receive second user layer information generated based on the first user layer information from the first user, and
wherein the user layer database is configured to store the second user layer information.

3. The map service system of claim 1, wherein the map processing server is configured to transmit the first user layer information stored in the user layer database to a user upon receipt of a request from the user for the first user layer,
wherein the map processing server is configured to receive second user layer information generated based on the first user layer information from the user who requested the first user layer,
wherein the user who requested the first user layer is the first user or a second user who is different from the first user.

4. The map service system of claim 1, wherein the user layer database includes second user layer information generated by the first user and third user layer information generated by a second user, and
the map processing server is configured to transmit the second and third user layer information relating to the geographical location to the first user according to a map information transmission request for the geographical location from the first user.

5. The map service system of claim 4, wherein the first user layer information is generated based on at least one selected from the group consisting of the base map information, the second user layer information, and the third user layer information according to a selection of the first user.

6. The map service system of claim 4, wherein first, second and third user layers correspond to the first, second and third user layer information, respectively,
wherein one or more of the first, second, and third user layers are displayed by overlapping them to a base map corresponding to the base map information.

7. The map service system of claim 1, wherein the base map information comprises basic layer information and at least one selectable base map layer information,
wherein the map processing server includes a base map management module to process the base map information and a user layer management module to process the user layer information.

8. The map service system of claim 1, wherein the object information comprises content data or link information linked to the content data.

9. The map service system of claim 1, wherein the object information comprises content information received from a user terminal of the first user.

10. The map service system of claim 1, further comprising:
a content database configured to store content information; and
a search server configured to provide the content information to the first user in response to a search query,
wherein the object information comprises the content information.

11. The map service system of claim 1, wherein the position identifier points to a position of an object corresponding to the object information in a base map corresponding to the base map information,
wherein the user layer database and the base map database are provided in different servers.

12. A method for providing a map service, the method comprising:
transmitting base map information comprising geographical information relating to a geographical region to a first user terminal;
receiving first user layer information which is generated at the first user terminal based on the base map information, the first user layer information comprising at least one object information and a position identifier associated with the object information; and
storing the first user layer information.

13. The map service method of claim 12, further comprising:
transmitting the first user layer information to the first user terminal upon receipt of a request for the first user layer information;
receiving second user layer information from the first user terminal, the second user layer information being generated using the first user layer information; and
storing the second user layer information.

14. The map service method of claim 12, further comprising:
transmitting the first user layer information to a second user terminal;
receiving second user layer information from the second user terminal, the second user layer information being generated using the first user layer information; and
storing the second user layer information.

15. The map service method of claim 12, further comprising:
storing second user layer information generated at the first user terminal and third user layer information generated at a second user terminal; and
transmitting the second and third user layer information relating to the geographical region to the first user terminal according to a map information transmission request for the geographical region from the first user terminal.

16. The map service method of claim 15, wherein the first user layer information is generated based on at least one selected from the group consisting of the base map information, the second user layer information, and the third user layer information. wherein the selection is made at the first user terminal.

17. The map service method of claim 15, wherein first, second, and third user layers correspond to the first, second, and third user layer information, respectively, wherein one or more of the first, second, and third user layers are displayed by overlapping them to a base map corresponding to the base map information.

18. The map service method of claim 12, wherein the base map information comprises basic layer information and at least one selectable base map layer information.

19. The map service method of claim 12, wherein the object information comprises content data or link information linked to the content data.

20. The map service method of claim 12, wherein the object information comprises content information provided from the first user terminal or from a communication network.

21. The map service method of claim 12, wherein the position identifier points to a position of an object corresponding to the object information in a base map corresponding to the base map information.

22. A computer-readable medium storing a program to execute the method of one of claims 12 to 17.
